(19) United States
(12) Patent Application Publication
(10) Pub. No.: US 2011/0297486 A1
(43) Pub. Date: Dec. 8, 2011

(54) FORKLIFT

(75) Inventors: Satoru Kaneko, Naka (JP); Takashi Ikimi, Hitachi (JP); Shiho Izumi, Hitachinaka (JP); Hidekazu Moriki, Hitachinaka (JP); Nobuo Masano, Kashiwa (JP)

(73) Assignee: HITACHI CONSTRUCTION MACHINERY CO., LTD., Bunkyo-ku, Tokyo (JP)

(21) Appl. No.: 13/201,468

(22) PCT Filed: Feb. 17, 2010
(86) PCT No.: PCT/JP2010/052378

§ 371 Date: Aug. 22, 2011

(30) Foreign Application Priority Data
Feb. 17, 2009 (JP) 2009-034076

(51) Int. Cl. B66F 9/24; H02P 5/74

(52) U.S. Cl. 187/233; 318/801

(57) ABSTRACT

[Object]

To enable stable cargo handling operation and high-efficiency recovery of regenerative electric power by means of simple configuration.

[Solution]

In a forklift which includes linear actuators that convert rotational motion into linear motion, the linear actuators being provided in a plurality of fork parts of a cargo handling drive device, the forklift includes induction motors that drive each of the plurality of actuators provided in the plurality of fork parts, an inverter that drives the induction motors in the same manner, and a controller that controls the inverter, and the controller computes a slip frequency by using the lowest detection value among detection values from detectors that detect each of rotation speeds of the plurality of induction motors.

### TECHNICAL FIELD

The present invention relates to a forklift, in particular, a forklift including a cargo handling device which makes it possible to achieve stable cargo handling operation by means of simple configuration.

### BACKGROUND ART

In recent years, from the viewpoints of environmental problems, high oil prices, and so on, there has been growing demand for energy saving in various products. For this reason, also in the field of construction vehicles and industrial vehicles which has hitherto centered on hydraulic drive systems using an engine, there has been an increasing number of instances in which higher efficiency and greater energy saving are promoted through electrification.

In addition to reduced exhaust gas emissions, various energy saving effects can be anticipated through electrification, i.e., use of a motor as a power source, such as high efficiency drive of the engine, improved transmission efficiency, and recovery of regenerative electric power. In particular, among the construction vehicles and industrial vehicles mentioned above, electrification of forklifts is most advanced. Battery-powered forklifts, which drive the motor by using electric power from the battery, have been put into practical use.

In battery forklifts that have already been commercialized, a lead-acid battery is used as the power source, the drive tires are directly driven by the motor, and further, the portion of a cargo handling device that does the work of raising and lowering a cargo is driven by an electro-hydraulic system. In this system, the hydraulic pump is driven by the motor, and the left and right cylinders of the forklift are actuated by the generated hydraulic pressure.

While the battery forklifts configured in this way are basically aimed at eliminating exhaust gas emissions when working in a warehouse, by exploiting the operation pattern of forklifts which repeats acceleration and deceleration, a reduction in energy consumption by use of regenerative electric power can be also anticipated.

However, the lead-acid battery used has poor rapid heavy-current charging characteristics, and thus the amount of regenerative electric power than can be actually recovered is trivial. For this reason, at present, a large-capacity capacitor is also used in combination to compensate for the poor rapid heavy-current charging characteristics of the lead-acid battery, and regenerative electric power is recovered by this capacitor to thereby reduce energy consumption.

In the case of a cargo handling device that does the work of raising and lowering a cargo, an opportunity for recovering stored potential energy exists when lowering the cargo. However, since it is difficult to recover this energy due to the structure of the hydraulic cylinder of the lift part, such energy is discarded at present.

For this reason, as the actuator on the lift part, it is now being considered to substitute the hydraulic cylinder by a motor-driven linear actuator to thereby efficiently recover regenerative energy that is generated when lowering a cargo.

In the case where a linear actuator is used in this way, it is possible to rotate the drive motor by an external force when lowering a cargo, and thus regenerative electric power can be generated by the motor.

A method of controlling the drive of a linear actuator is disclosed in Patent Literature 1. According to this literature, this lifting system has electric cylinders (corresponding to linear actuators) on the left and right. Regenerative braking is performed during descent of the lifting system by using these two electric cylinders synchronously, thereby enabling recovery of regenerative energy.

### CITATION LIST

### Patent Literature

Patent Literature 1: JP-A No. 2005-53693

### SUMMARY OF INVENTION

### Technical Problem

In the case where a linear actuator is placed on the left and right of a forklift as in the lifting system according to the related art mentioned above, it is necessary to secure coordination between the left and right actuators. In the above-mentioned lifting system, for each of the left and right motors, an inverter and an encoder that drive each of the motors are provided. When the difference in rotation speed between the respective motors that drive the left and right linear actuators becomes equal to or greater than a predetermined value, the difference in rotation speed between the left and right motors is controlled to be within a predetermined range by adjusting the respective output voltages of the left and right inverters.

In this way, according to the related art, to keep the difference in rotation speed between the two left and right motors within a predetermined range, an inverter and a rotation sensor are provided for each of the two left and right motors to perform synchronization control. In this case, since an inverter is provided for each of the two left and right motors, this drives up cost, and can also present a problem in terms of mounting. Moreover, since the respective motors are inverter-controlled to eliminate the difference in rotation speed between the left and right motors, the resulting control also becomes complex.

The present invention has been made in view of these problems, and provides a forklift including a cargo handling device which enables stable cargo handling operation and high-efficiency recovery of regenerative electric power by means of simple configuration.

### Solution to Problem

To solve the above-mentioned problems, the present invention adopts the following means.

In a forklift which includes linear actuators that convert rotational motion into linear motion, the linear actuators being provided in a plurality of fork parts of a cargo handling drive device, the forklift includes induction motors that drive each of the plurality of actuators provided in the plurality of fork parts, an inverter that drives the induction motors in the same manner, and a controller that controls the inverter, and the controller computes a slip frequency by using the lowest detection value among detection values from detectors that detect each of rotation speeds of the plurality of induction motors.

### Advantageous Effects of Invention

Since the present invention includes the above-mentioned configuration, it is possible to achieve stable cargo handling operation and high-efficiency recovery of regenerative electric power by means of simple configuration.

### BRIEF DESCRIPTION OF DRAWINGS

FIG. 1 is a diagram illustrating a forklift including a cargo handling device.

FIG. 2 is a diagram illustrating a hydraulic drive system in the case where regeneration is performed by using hydraulic pressure.

FIG. 3 is a diagram showing an example in which a drive motor and an inverter are placed for each of left and right actuators to thereby raise and lower a fork part.

FIG. 4 is a diagram illustrating the basic configuration of a motor drive device.

FIG. 5 is a block diagram illustrating an induction motor control system that controls induction motors by using an inverter.

FIG. 6 is a diagram illustrating a motor control system when two motors are controlled by a single inverter.

FIG. 7 is a diagram showing the characteristic of torque with respect to the slip frequency of an induction motor.

### DESCRIPTION OF EMBODIMENTS

Hereinafter, the best mode of embodiment will be described with reference to the attached drawings.

As described above, the cargo handling device of a forklift is generally formed by a hydraulic drive system. This forklift is roughly divided into two types, an engine-powered type and a battery-powered type. The drive source for the cargo handling device hydraulic system in each of the forklifts is either an engine or a motor.

As described above, in the field of forklifts, the advancing move toward higher efficiency and greater energy saving through electrification of their drive device is in common. For battery-powered forklifts, in particular, active attempts are now being made to recover regenerative electric power that is generated when decelerating during travel.

For forklifts, it is expected that further energy saving efforts will be made in the future, and after recovery of regenerative electric power during travel, the next step that will be considered is recovery of energy from the cargo handling device. Recovery of energy from the cargo handling device means recovering an amount of energy equivalent to the potential energy when a cargo is lowered from an elevated position, which is considered to offer the greatest energy saving effect of all energy saving means.

When lowering a cargo from an elevated position by using the above-mentioned hydraulic drive system, the cargo is lowered by reducing the bearing force by releasing the hydraulic pressure within the hydraulic cylinder. That is, stored potential energy is consumed in the form of release of hydraulic pressure.

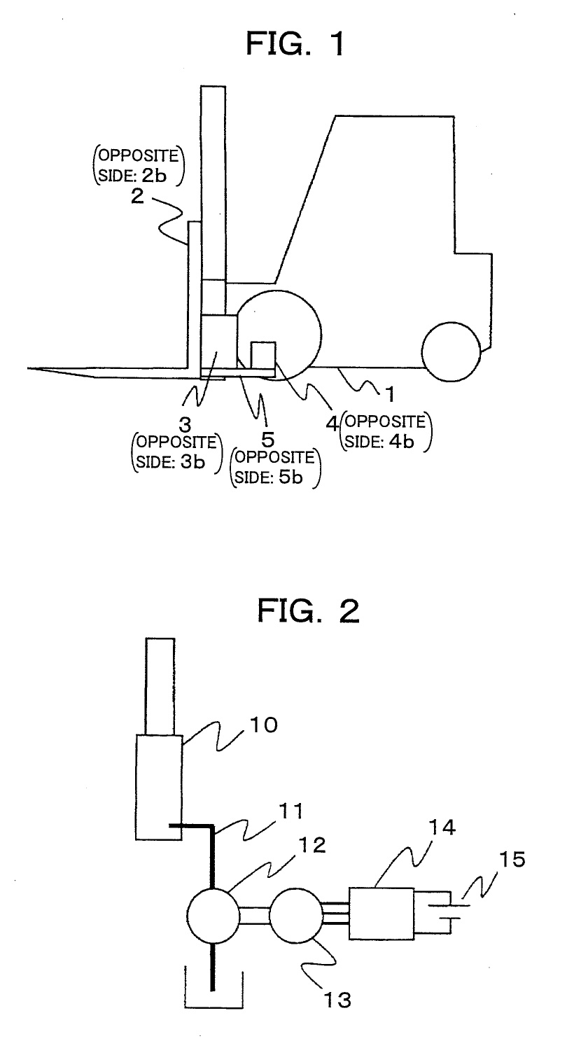

FIG. 1 is a diagram illustrating a forklift including a cargo handling device according to the present invention. As shown in FIG. 1, in a forklift 1, a fork part 2 that makes vertical motion is provided at the front of its body, and the drive to raise and lower the fork part 2 is done by a linear actuator 3.

The linear actuator includes, for example, a ball screw, and is a linear actuator that converts rotational motion of a drive motor into linear motion with high efficiency. While in FIG. 1 a drive motor 4 is configured to drive the linear actuator 3 via a gear 5, the present invention is not limited to this mode. For example, the linear actuator 3 may be directly driven by the drive motor 4. Although not explicitly shown in FIG. 1, a fork part 2b, a linear actuator 3b, and a drive motor 4b are likewise provided on the right side (the side opposite to the drawing) of the forklift. The cargo handling device of the forklift mentioned above is driven so as to be raised and lowered by the two left and right actuators.

FIG. 2 is a diagram illustrating a hydraulic drive system in the case where regeneration is performed by using hydraulic pressure. In this system, oil from a hydraulic cylinder 10 that causes the lift to ascend and descend when lowering a cargo returns to a hydraulic motor 12 via a hydraulic pipe 11, causing the hydraulic motor 12 to rotate. This rotary force causes a generator 13 to rotate, generating electric power. This generated electric power is charged and stored in a battery 15 via a converter 14. In the case of a regeneration method that regenerates energy via hydraulic pressure in this way, although replacement from hydraulic systems according to the related art is relatively easy. However, since regenerative energy is sequentially transmitted to the hydraulic pipe, the hydraulic motor, and the generator, the loss in each of these portions is large, making it sometimes impossible to obtain sufficient regenerative electric power.

In contrast, in the case of using a linear actuator that converts rotational motion of the motor mentioned above directly into linear motion, it is possible to improve the low efficiency of hydraulic drive systems to allow for efficient regeneration of stored potential energy.

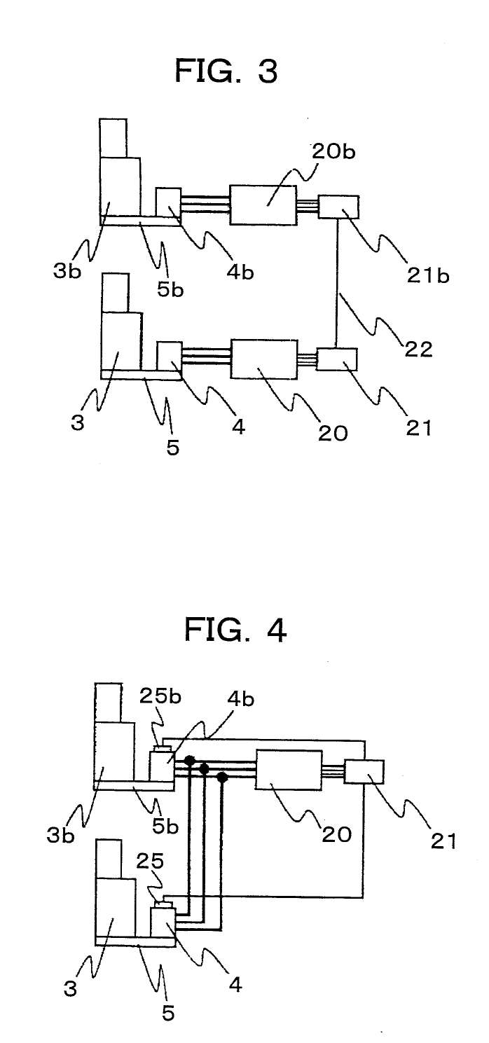

FIG. 3 is a diagram showing an example in which a drive motor and an inverter for driving the drive motor are placed for each of the left and right actuators, and the fork part is raised and lowered by the left and right actuators.

In the case of this example, it is necessary to secure coordination between the left and right motors in such a way as to eliminate the speed difference between the left and right actuators. To secure coordination between the left and right actuators, it is necessary to monitor the rotation speeds and torques of the left and right drive motors, and the thrusts of the actuators, or the moving speeds of the actuators, and control the left and right drive motors so as to eliminate their differences. That is, inverters 20 and 20b that respectively supply electric power to the left and right drive motors 4 and 4b need to be controlled by detecting the states of the corresponding motors or actuators, and exchanging the detection values between their respective controllers 21 and 21b.

For this purpose, in the example shown in FIG. 3, the controllers 21 and 21b are connected to each other by a communication line 22 in the manner of a signal, and various detection signals are transmitted and received via the communication line 22. In the example shown in FIG. 3, illustration of various sensor signals inputted to each controller is omitted. However, in actuality, various sensors are attached to each motor or inverter, and signals from those sensors are inputted to each controller.

In the case where the left and right actuators are controlled by a motor and an inverter attached for each of the actuators in this way, it is possible to compensate for the speed difference between the left and right actuators. However, in this case, various sensors are required, which adds complexity to the control. Moreover, this causes an increase in cost. Furthermore, an inverter is necessary for each of the left and right actuators, which can sometimes present a problem in terms of mounting.

FIG. 4 is a diagram illustrating the basic configuration of a motor drive device. As shown in FIG. 4, the motors 4 and 4b that drive the left and right actuators 3 and 3b, respectively, are driven by a single inverter 20.

Here, if synchronous motors are used as the drive motors 4 and 4b, it is necessary to determine the phase of the output voltage from the inverter in accordance with the positions of magnetic poles on the rotor of each of the motors. For this reason, it is difficult to drive a plurality of motors by a single inverter. In contrast, in the case where induction motors are used as the drive motors 4 and 4b, it is easy to drive a plurality of motors by a single inverter.

That is, since an induction motor creates the magnetic flux position on the secondary side inside its own controller, control that does not depend on the rotational position of each motor is possible, and further, since motor torque is determined in accordance with the slip frequency (motor rotation speed), which is produced in balance with the load exerted on the rotor with respect to the frequency applied to the primary coil of the motor, even when a plurality of motors are connected to a single inverter, torque can be obtained in a stable manner from each of the motors.

For this reason, in this embodiment, a plurality of (i.e., two) induction motors are driven by a single inverter. It should be noted that information on motor rotation speed is necessary to control the induction motors. For this purpose, in the example shown in FIG. 4, speed sensors 22 and 22b are attached to the left and right drive motors 4 and 4b, respectively, and the rotation speed of each of the motors is inputted to the controller 21.

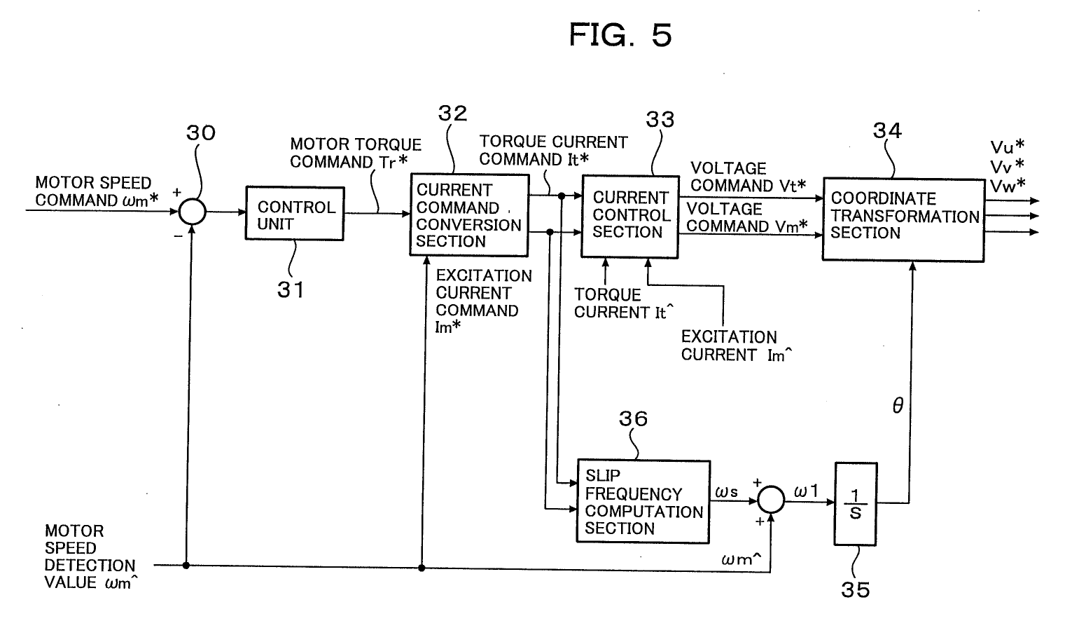

FIG. 5 is a block diagram illustrating an induction motor control system that controls induction motors by using an inverter. The block diagram in FIG. 5 represents a motor rotation speed control system. A difference unit 30 computes the difference between a motor speed command ωm* determined by an upper control system, and a speed detection value ωm̂ of the motor to be controlled which has been fed back. A control unit 31 that takes the computation result as input computes a motor torque command Tr*. Here, the control unit 31 is formed by a proportional control unit, a proportional-plus-integral control unit, or the like.

A current command conversion section 32 takes the motor torque command Tr* and the motor rotation speed ωm̂ as input, and computes a torque current command It* and an excitation current command Im*. A current control section 33 generates voltage commands Vt* and Vm* by feeding back the actual current detection values It̂ and Im̂ to the above-mentioned computed torque current command It* and excitation current command Im*. It should be noted that like the control unit 31 mentioned above, the current control section 33 is formed by a proportional-plus-integral control unit or the like.

The voltage commands computed by the current control section 33 mentioned above are voltage commands Vt* and Vm* for two rotating coordinate axes. A coordinate transformation section 34 computes a coordinate transformation on the voltage commands Vt* and Vm* by using the rotational phase θ of the magnetic flux for two rotating coordinate axes, and outputs AC voltage commands Vu*, Vv*, and Vw*. It should be noted that this rotational phase θ is obtained by computing the integral of a primary frequency ω1 by an integrator 35. As represented by Equation 1, the primary frequency ω1 can be obtained by summing the detection value ωm̂ of motor speed and a slip frequency ωs.

ω1=ωm̂+ωs (Equation 1)

Within a given range of slip ratio, the torque of an induction motor is proportional to the slip frequency ωs. For this reason, it is possible to adjust motor torque by adjusting slip frequency. It should be noted that the slip frequency ωs can be calculated in a slip frequency computation section 36 on the basis of (Equation 2).

ωs=R2×It/(L2×Im) (Equation 2)

Here, R2 denotes secondary-side resistance value, and L2 denotes secondary-side self inductance. Since it is common to use command values for the above-mentioned torque current It and excitation current Im, for use in actual computation, the numerical values need to be set by taking a control delay or the like into consideration.

In the foregoing, with reference to the example shown in FIG. 5, a description has been given of the case of driving a single motor as a control target by a single inverter. In this embodiment, on the basis of such a control system, two induction motors are controlled by a single inverter.

Incidentally, unlike a synchronous motor, an induction motor rotates with a slip frequency as described above. Accordingly, the induction motor can produce torque in balance with the load. Due to such a characteristic, it is possible to drive a plurality of (two) induction motors by a single inverter. However, for the cargo handling device of a forklift, smooth raising and lowering action is difficult unless the difference in rotation speed between the left and right motors is minimized. For this purpose, according to this embodiment, in applying the induction motor control system described above with reference to FIG. 5 to the left and right induction motors of the cargo handling device for forklift, the value to be fed back is optimized in such a way as to eliminate the speed difference. It should be noted that in controlling the linear actuators 3 and 3b of the cargo handling device, to make their behavior the same as the behavior of the hydraulic cylinder in machines according to the related art, constant speed control is employed. Although there is no problem with employing torque control, since it is necessary to change the command value in accordance with the load whenever necessary, it cannot be said that torque control is suited for driving of the cargo handling device.

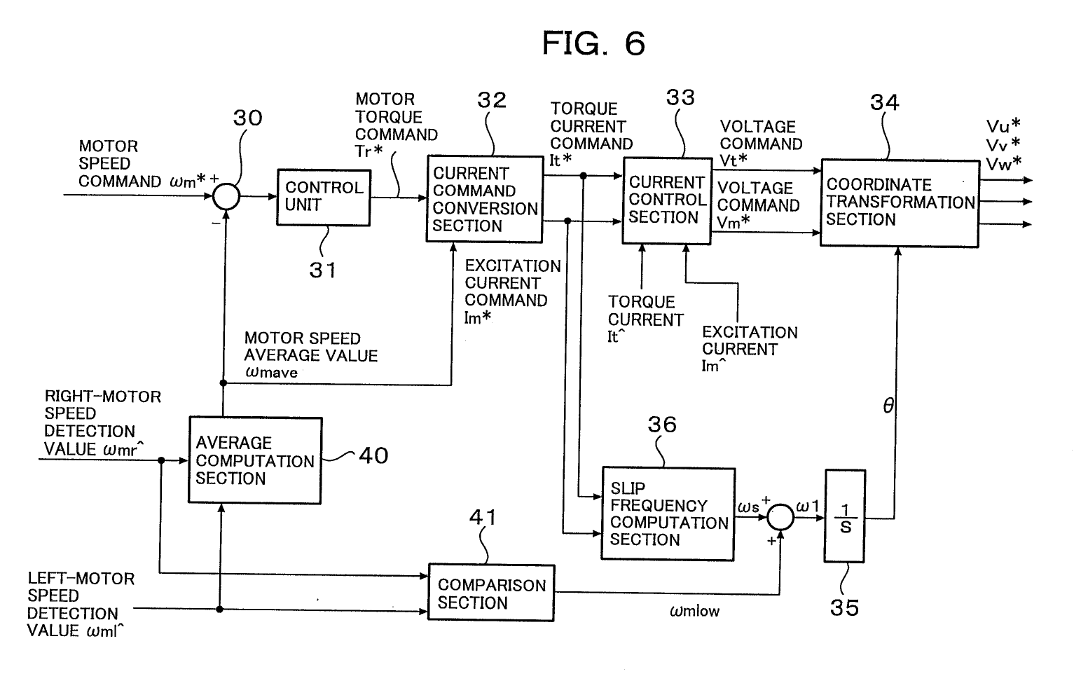

FIG. 6 is a diagram illustrating a motor control system when two motors are controlled by a single inverter. It should be noted that the above-mentioned two motors drive the respective actuators attached to the fork parts. It should be noted that in FIG. 6, portions that are the same as those shown in FIG. 5 are denoted by the same symbols, and their description is omitted. In this example, of the detection values from detectors that detect the rotation speeds of the respective motors that drive the left and right actuators, the lowest detection value is fed back to thereby compensate for the speed difference between the left and right actuators.

As shown in FIG. 6, the motor rotation speeds to be fed back to the motor control system are a right-motor rotation speed ωmr̂ and a left-motor rotation speed ωml̂. An average computation section 40 computes the average value ωmave of the two motor rotation speeds. Then, this average value ωmave of motor rotation speed is fed back to the difference unit 30. Subsequently, on the basis of the difference computed in the difference unit 30, the control unit 31 computes an average torque command Tr* required for the lift to ascend and descend at the same speed as the command value.

A comparison section 41 compares the right-motor rotation speed ωmr̂ and the left-motor rotation speed ωml̂, and allows the lower rotation speed ωmlow of the two speeds to pass. The comparison section 41 adds the passed value ωmlow to the slip frequency ωs as indicated in (Equation 1), thereby obtaining the primary frequency ω1 to be applied to each of the drive motors 4 and 4b. It should be noted that in the case where three or more motors are driven, the rotation speed of the motor with the slowest speed may be added to the slip frequency ωs.

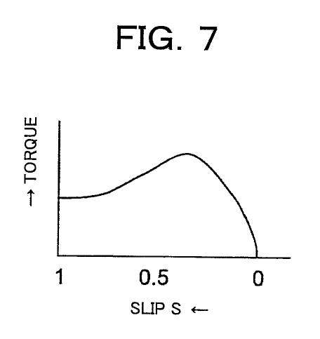

FIG. 7 is a diagram showing the characteristic of torque with respect to the slip frequency of an induction motor. In FIG. 7, the horizontal axis S represents slip ratio. It should be noted that the slip ratio S is defined by (Equation 3).

S=(Ns−Nr)/Ns (Equation 3)

Here, Ns denotes the frequency (primary frequency) of the rotating magnetic field applied, and Nr denotes the frequency of the rotor. It should be noted that in (Equation 3), (Ns−Nr) corresponds to the slip frequency ωs. Generally speaking, the range of slip ratio S is a very small value in the operating region normally used. That is, in the range normally used, as shown in FIG. 7, characteristically, the motor torque becomes greater as the slip frequency ωs becomes larger.

In this embodiment, to eliminate the speed difference between the left and right actuators, it is necessary to decrease the torque of the motor that is driving the actuator with the faster moving speed and, conversely, increase the torque of the motor that is driving the actuator with the slower moving speed.

Accordingly, as described above, of the two left and right motors, the detection value of rotation speed of the motor with the lower rotation speed is selected, and this value is used for computation of the primary frequency, thereby decreasing the slip frequency of the motor with the relatively higher rotation speed. This makes it possible to decrease the motor torque of the motor with the higher rotation speed. In contrast, for the motor with the lower motor rotation speed, the detection value of the lower motor rotation speed is used as it is, and thus it is possible to produce required torque.

In this way, of the rotation speeds of the two left and right motors, the detection value for the motor with the lower speed is used for computation of the primary frequency, thereby making it possible to decrease the torque of the motor with the higher speed. This makes it possible to eliminate the speed difference between the left and right actuators.

For example, in the case of a four-pole induction motor that outputs rated torque at a slip ratio of 5%, when the rotating magnetic field frequency (primary frequency) Ns is 1500 rpm (motor angular frequency of 313.37 rad/sec), the motor rotation speed Nr that can output rated torque is determined as 1425 rpm from (Equation 3).

Now, in the case where two motors are driven by a single inverter as in this embodiment, provided that the difference in rotation speed between the left and right motors is 5%, when the primary frequency Ns is computed by using the rotation speed of the motor with the lower motor rotation speed as in the motor control system shown in FIG. 6, the lower motor rotation speed is 1425 rpm, whereas the higher motor rotation speed is 1425 rpm×1.05=1496.25 rpm (motor angular frequency of 313.37 rad/sec).

On the basis of (Equation 3), the slip ratio S of the motor with the higher rotation speed at this time is (314.16−313.37)/314.16=0.0025 (0.25%). In an induction motor, since torque and slip ratio generally vary linearly in the slip range normally used, when the slip ratio is 0.25%, the motor torque becomes approximately 1/20 of the rated torque (0.25%/5%).

In this way, by using the value of the lower motor rotation speed for computation of the primary frequency Ns used in the motor control system, the torque of the motor whose rotation speed has become relatively high can be made smaller. Thus, it can be appreciated that the control acts to make the speed difference between the left and right motors smaller.

It should be noted that in FIG. 6, as each of the torque current detection value It̂ and the excitation current detection value Im̂ to be fed back to the current control section 33, the total value or average value of the currents flowing in the two motors may be fed back. Also, since basically the same type of motor is used for the two motors, the current in one of the left and right motors may be fed back.

As has been described above, according to the embodiment of the present invention, in a forklift which has linear actuators that convert rotational motion of a motor into linear motion in two left and right fork parts, induction motors are used as the motors that drive the two left and right linear actuators, and the two left and right motors are driven by a single inverter. At this time, the cargo handling device has a controller that controls the output voltage of the inverter. The controller constitutes a feedback control system for the rotation speed of each of the motors, and the motor speed to be fed back to the rotation speed control system is the average value of the speed detection values for the two left and right motors. Further, in the portion of the controller which computes the slip frequency of each of the motors, as the motor rotation speed used for computing the slip frequency, detection values from rotation sensors on the two left and right motors are compared, and the lower speed detection value of the compared detection values is used. That is, as the motor speed to be fed back to the rotation speed control system, the average value of speed detection values for the two left and right motors is used, and further, as the motor rotation speed used for computing the motor slip frequency, the lower speed detection value of the detection values from the rotation sensors on the left and right motors is used. By means of such simple configuration, it is possible to achieve stable cargo handling operation and high-efficiency recovery of regenerative electric power.

### REFERENCE SIGNS LIST

1 Forklift
2 Fork part
3 Linear actuator
4 Drive motor
5 Gear
10 Hydraulic cylinder
11 Hydraulic pipe
12 Hydraulic motor
13 Generator
14 Converter
15 Battery
20 Inverter
21 Controller
25 Speed sensor
31 Control unit
32 Current command conversion section
33 Current control section
34 Coordinate transformation section
36 Slip frequency computation section
40 Average computation section
41 Comparison section

1. A forklift which includes linear actuators that convert rotational motion into linear motion, the linear actuators being provided in a plurality of fork parts of a cargo handling drive device, comprising:
induction motors that drive each of the plurality of actuators provided in the plurality of fork parts;
an inverter that drives the induction motors in the same manner; and
a controller that controls the inverter,
wherein the controller computes a slip frequency by using the lowest detection value among detection values from detectors that detect each of rotation speeds of the plurality of induction motors.

2. A forklift which includes linear actuators that convert rotational motion into linear motion, the linear actuators being provided in a plurality of fork parts of a cargo handling drive device, comprising:
induction motors that drive each of the plurality of actuators provided in the plurality of fork parts;
an inverter that drives the induction motors in the same manner; and
a controller that controls the inverter,
wherein the controller computes a torque command by feeding back, to a rotation speed control system, an average value of detection values from detectors that detect each of rotation speeds of the plurality of induction motors.

3. A forklift which includes linear actuators that convert rotational motion into linear motion, the linear actuators being provided in a plurality of fork parts of a cargo handling drive device, comprising:
induction motors that drive each of the plurality of actuators provided in the plurality of fork parts;
an inverter that drives the induction motors in the same manner; and
a controller that controls the inverter,
wherein the controller feeds back, to a rotation speed control system, an average value of detection values from detectors that detect each of rotation speeds of the plurality of induction motors, and computes a slip frequency by using the lowest detection value among the detection values from the detectors that detect each of the rotation speeds of the plurality of induction motors.

4. The forklift according to any one of claims 1 to 3, wherein the linear actuators each include a ball screw mechanism that converts rotational motion of each of the induction motors into linear motion to drive a fork in a vertical direction.
